(19) United States
(12) Patent Application Publication
(10) Pub. No.: US 2006/0082345 A1
(43) Pub. Date: Apr. 20, 2006

(54) Rechargeable alkaline battery with overcharging protection

(76) Inventors: Josef Daniel-Ivad, Newmarket (CA); David Zhang, Scarborough (CA)

Correspondence Address: ANISSIMOFF & ASSOCIATES;RICHMOND NORTH OFFICE CENTRE, SUITE 201, 235 NORTH CENTRE RD., LONDON, ON, N5X 4E7, CA

(21) Appl. No.: 11/211,433

(22) Filed: Aug. 26, 2005

Related U.S. Application Data
(60) Provisional application No. 60/604,430, filed on Aug. 26, 2004.

(51) Int. Cl. H02J 7/00

(52) U.S. Cl. 320/134

(57) ABSTRACT

A rechargeable alkaline manganese (RAM) battery or battery pack comprising an overcharging protection circuit that allows the RAM battery or battery pack to be charged using a charging circuit designed for use with a different type of rechargeable battery, for example a NiCd or NiMH rechargeable battery. The battery of the present invention is particularly advantageous as a replacement battery for use in devices having an embedded charging circuit designed for use with NiCd or NiMH batteries. The overcharging protection circuit may be provided in a battery pack that allows the individual RAM cells to be removed and replaced. Alternatively, the overcharging protection circuit may be installed in the device itself. When the battery pack is provided as original equipment in an electronic device, an activation key may be provided that prevents discharge of the batteries before the device is used.

### CROSS REFERENCE TO RELATED APPLICATIONS

This application claims the benefit of U.S. 60/604,430, filed Aug. 26, 2004, which is hereby incorporated herein by reference.

### FIELD OF THE INVENTION

The invention relates to rechargeable alkaline manganese (RAM) batteries. More particularly, the invention relates to RAM batteries having an overcharging protection circuit built into the battery.

### BACKGROUND OF THE INVENTION

Disposable or single-use alkaline batteries have been used as sources of electrical power in a variety of applications. In electronic devices, single-use alkaline batteries, or primary cells, provide an inexpensive and long-lasting power supply. Nonetheless, in some high-drain and repeated use applications consumers demand a rechargeable power supply to reduce the need to change batteries and to reduce operational cost. For example, cordless phones typically use the rechargeable nickel-cadmium (NiCd) battery system as a power source in a battery pack configuration of 2 to 4 cells in-series. NiCd batteries are readily available at a reasonable cost from a large number of suppliers and the charging circuitry for these batteries is usually very simple. However, the NiCd battery uses Cadmium (Cd) as an active electrochemical ingredient, which is extremely toxic and should be avoided from an environmental point of view. In addition, NiCd batteries exhibit a “memory effect” if recharged prior to complete discharge that limits the amount of charge that can be accepted by the battery, thereby reducing the effective duration with which an electronic device can be used. Another rechargeable battery is the nickel-metal hydride (NiMH) battery. Although these batteries do not exhibit a noticeable “memory effect” as previously described, the cost of these batteries is significantly greater than NiCd. For these reasons and others, it is desirable to provide an alternative rechargeable battery that is inexpensive, does not exhibit a “memory effect”, and is environmentally benign. It is further desirable to provide such a battery in a manner that permits easy replacement of NiCd or NiMH batteries in existing electronic devices without modification of the built-in charging circuit.

Rechargeable alkaline manganese (RAM) batteries are secondary cells that overcome many of the aforementioned problems with NiCd and NiMH batteries. These batteries are described in U.S. Pat. Nos.: 5,281,497; 5,424,145; 5,626,988; 6,099,987; and, 6,361,899, which are hereby incorporated by reference. When RAM batteries are charged using the voltages provided in charging circuits designed for use with NiCd batteries, dangerous conditions such as off-gassing and cell leakage can result. Special chargers are therefore normally required for RM batteries. Although it would be desirable to replace the original equipment manufacturer (OEM) NiCd or NiMH battery packs in existing electronic devices with RM battery packs, the embedded charging circuits in those devices are incompatible with RAM batteries and would cause overcharging. There is therefore still a need for an alternative rechargeable battery that can be safely recharged using an existing charging circuit (in an existing electronic device) that is meant for use with a different type of rechargeable battery.

### SUMMARY OF THE INVENTION

A rechargeable alkaline manganese (RAM) battery or battery pack comprising an overcharging protection circuit that allows the RAM battery or battery pack to be charged using a charging circuit designed for use with a different type of rechargeable battery, for example a NiCd or NiMH rechargeable battery. The battery of the present invention is particularly advantageous as a replacement battery for use in devices having an embedded charging circuit designed for use with NiCd or NiMH batteries. The overcharging protection circuit may be provided in a battery pack that allows the individual RAM cells to be removed and replaced. Alternatively, the overcharging protection circuit may be installed in the device itself. When the battery pack is provided as original equipment in an electronic device, an activation key may be provided that prevents discharge of the batteries before the device is used.

The overcharge protection circuit comprises a rectifier, a shunt regulator, and a voltage divider. The rectifier prevents back-charging of the charging circuit through discharge of the battery. The shunt regulator allows the charging circuit to charge the battery until a specified voltage has been reached, after which the battery is by-passed. The voltage divider limits the voltage supplied by the charging circuit to a suitable value for safely charging the RAM battery. The exact arrangement of components in the overcharge protection circuit is unimportant, provided that these three functions are provided. Some or all of the components of the overcharge protection circuit could be replaced by integrated circuits that perform the functions previously described without affecting the way in which the invention works. The overcharge protection circuit may be provided separately or integrated with the RAM battery or battery pack and co-operates therewith to achieve a desired result; that is, the safe charging of the RAM battery or battery pack by an existing charging circuit meant for use with a different type of rechargeable battery.

### BRIEF DESCRIPTION OF THE DRAWINGS

Having summarized the invention, preferred embodiments thereof will be described with reference to the accompanying figures, in which:

FIG. 1a shows a 2-cell series embodiment of the present invention;

FIG. 1b shows another 2-cell series embodiment of the present invention;

FIG. 2a shows a 3-cell series embodiment of the present invention;

FIG. 2b shows another 3-cell series embodiment of the present invention;

FIG. 3a shows a 4-cell series embodiment of the present invention; and,

FIG. 3b shows another 4-cell series embodiment of the present invention.

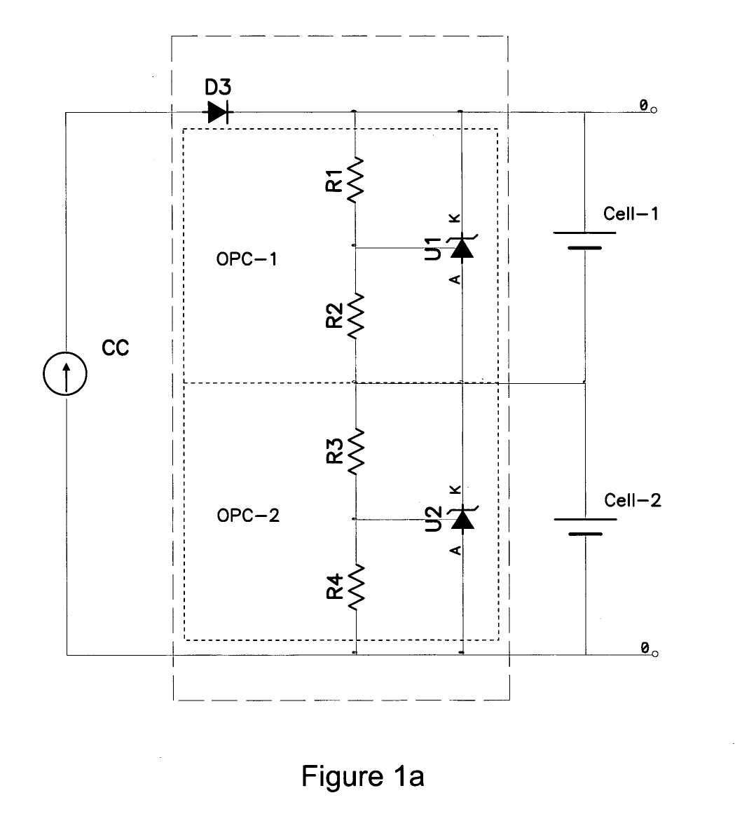

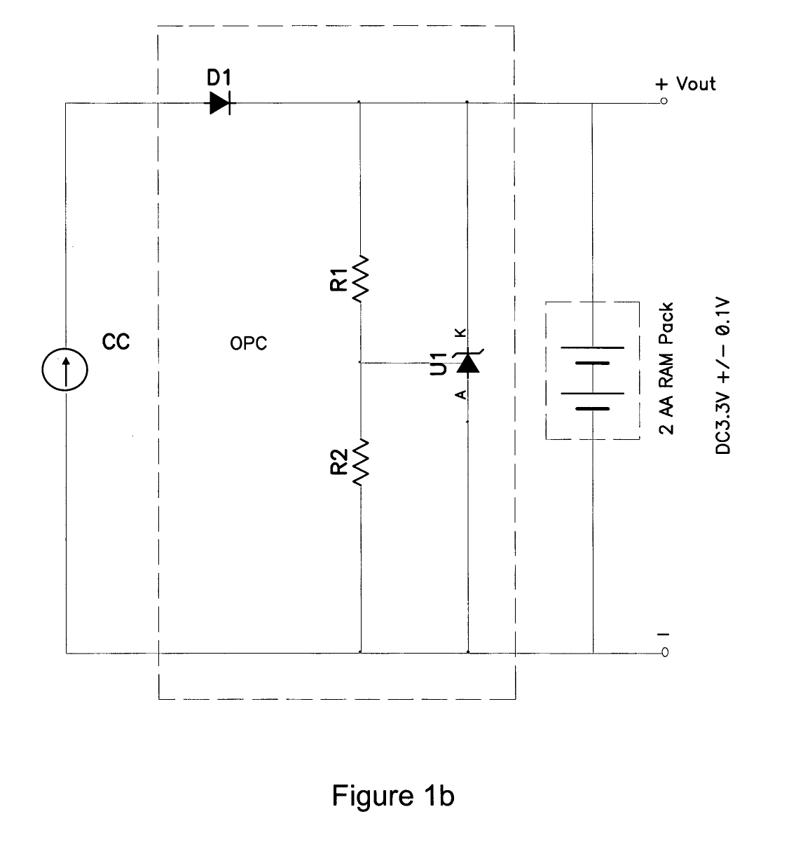

Referring to FIG. 1a, the 2-cell series RAM battery pack comprises the following components:
a) 2 RAM cells, preferably AA or AAA RAM cells;
b) an overcharge protection circuit for single cell voltage protection;
c) an activation switch;
d) interconnecting tabs; and,
e) a terminal connector.

Specifications for components in FIG. 1a are described in Table 1a, below:

TABLE 1a
Component specifications in FIG. 1a.

| Component | Description | Specification |
|---|---|---|
| CC* | Constant current | 100 mA |
| | power supply | |
| U1, U2 | Shunt regulator | AMS431LCM |
| | | (SOT23-3, |
| | | 1.24 V/100 mA, 2%) |
| | | or AMS431LCN |
| | | (TO-92, |
| | | 1.24 V/100 mA, 2%) |
| D3 | Rectifier | 1N4001 |
| R1, R3 | Resistors | 13 K/0.1 W/5% |
| R2, R4 | Resistors | 43 K/0.1 W/5% |

The principle of the overcharge protection circuit (OPC) in FIG. 1a will now be described.

Each cell is in parallel with a sub-circuit, OPCₓ, of the overcharging protection circuit. For example, cell-1 is in parallel with OPC-1 that comprises a shunt regulator U1, along with a voltage divider comprising resistors R1 and R2.

As long as cell-1 voltage is low all charge current flows through the cell. As soon as the cell voltage reaches a specified charge voltage (for example, 1.65V), charge current is by-passed by the shunt regulator U1 and does not charge the cell-1, thus keeping the cell voltage at 1.65V to avoid overcharging of the RAM cell.

The voltage divider comprising resistors R1 & R2 determines the final charge voltage supplied to the RAM cell. The rectifier diode D3 prevents RAM cell discharge by back-feeding the constant current (CC) power source.

The same principle applies to the cell-2.

Although the overcharge protection circuit is normally used with a CC power source (for example, a solar panel, a current regulated power supply, etc), it may be adapted for connection to a constant voltage (CV) power source in special situations.

The nominal voltage (at load current 100 mA) of the CC power supply should be higher than the total voltage of the cells in series. In this embodiment, the CC power supply is specified around 100 mA (max. <110 μA) for the AMS431LCN, etc. However, the shunt regulator still has a low rate of electronic leakage. For instance, the shunt regulator AMS431 LCN in FIG. 1a, has a leakage current of 5 μA (tested at Vₖₐ=1.5V), which drops to about 24 μA (tested at Vₖₐ=1.3V). If the circuit is connected to the cells prior to usage in an electronic device, this electronic leakage will discharge about 15% of an AA cell capacity in one year if no re-charging occurs. In addition, resistors R1-R4, will draw a small electronic leakage current of about 27 μA, which will discharge an additional 12% of the cell's capacity. For AAA cells, which have a lower overall cell capacity, the same leakage current results in about double the capacity loss as a percentage. To reduce leakage and related capacity loss, it is therefore desirable that the cells are not connected to the charge circuit prior to initial use in the device.

In one embodiment of the rechargeable battery or battery pack of the present invention, an activation key may be used for a fresh battery pack installed in a charging circuit to prevent cell leakage prior to initial use in the device. The activation key functions as a switch that disconnects the charge circuit from the battery when the batteries are not in use or are in storage at no load. The activation key may comprise an electrically non-conductive “pull tab” that is placed between two contacts to interrupt the connection between the battery and the charging circuit. The pull tab is removed prior to using the device to permitting recharging of the battery via the overcharge protection circuit. An alternative activation key means could be a conventional two pin jumper contact; in this case, the connection with the charge circuit is interrupted when the jumper is removed and installation of the jumper “key” connects the two jumper contacts, permitting the charging circuit to operate. Other suitable activation switch means can be used as long as they fulfill the requirement of preventing electronic leakage while the battery packs are in storage at no load (for example, while on the shelf in a retail store).

The overcharge protection circuit may be provided either as part of a battery pack or separately installed within the device. Irregardless of the foregoing, the individual cells may be removable from the overcharging protection circuit to permit replacement thereof.

Referring to FIG. 1b, an integrated 2-cell series RAM battery pack, wherein the cells are permanently connected in series during the lifetime of the cells in a single package along with the overcharge protection circuit, comprises the following components:
a) 2 RAM cells, preferably AA or AAA RAM cells;
b) an overcharge protection circuit for pack voltage protection;
c) an activation switch;
d) interconnecting tabs; and,
e) a terminal connector.

Specifications for components in FIG. 1b are described in Table 1 b, below:

TABLE 1b
Component specifications in FIG. 1b.

| Component | Description | Specification |
|---|---|---|
| CC* | Constant current | 100-150 mA |
| | power supply | |
| U1 | Shunt regulator | AMS431CN (TO92, |
| | | 2.5 V/150 mA, 1%) |
| | | or AMS431CM |
| | | (SOT-23, |
| | | 2.5 V/150 mA, 1%) |
| D1 | Rectifier | 1N4001 |
| R1 | Resistors | 47 K/0.1 W/5% |
| R2 | Resistors | 160 K/0.1 W/5% |

In tests it was shown that when a series RAM battery pack is charged by a low rate CC power supply, the voltage of the cells in the pack stays equal over a number of cycles. Based on this principle, the OPC can be simplified for a pack application. An embodiment of an OPC for charging a RAM battery pack having two AA cells in series is shown in FIG. 1b. The principle for this OPC is similar to FIG. 1a, and reaches a final charge voltage of 3.3V (1.65V per cell) at the battery pack. It should be noted that this circuit has a lower electronic leakage than the circuit shown in FIG. 1a. The shunt regulator (AMS431CN) has 50 μA (tested at Vₖₐ=3V), which drops to about 25 μA (tested at Vₖₐ=2.6V), therefore discharges about 15% of AA cell capacity in one year, and resistors R1-R2, will draw an additional small electronic leakage current of about 15 μA, which will discharge an additional 7% capacity. An activation key as previously described may be used in conjunction with the battery pack of this embodiment to prevent the leakage current from draining the battery prior to initial use in the device. This embodiment of the battery is especially well suited for use in existing electronic devices as a replacement battery.

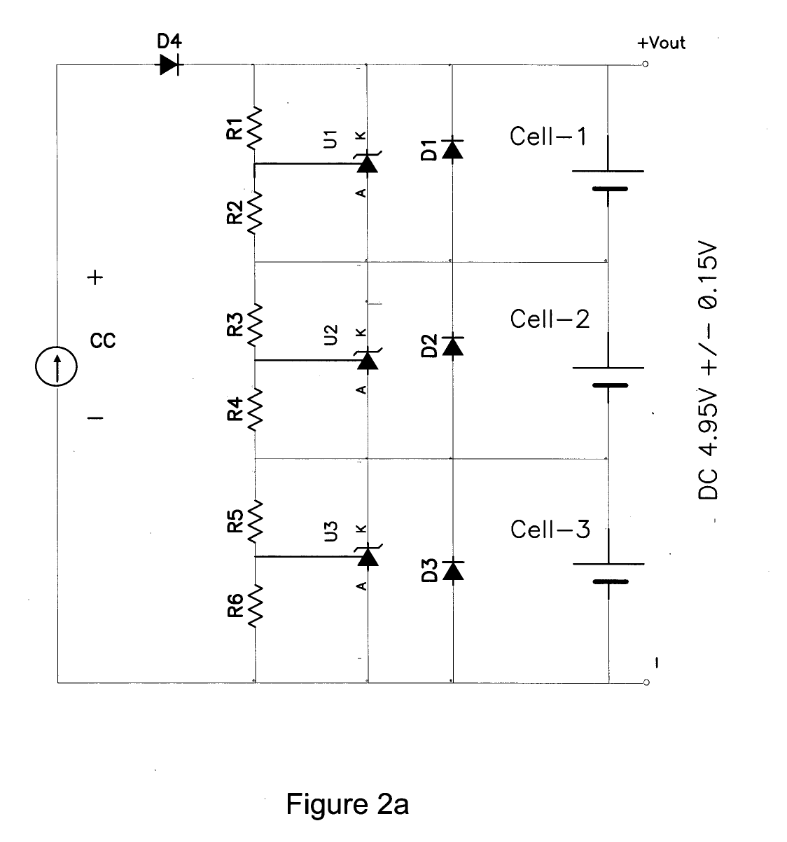

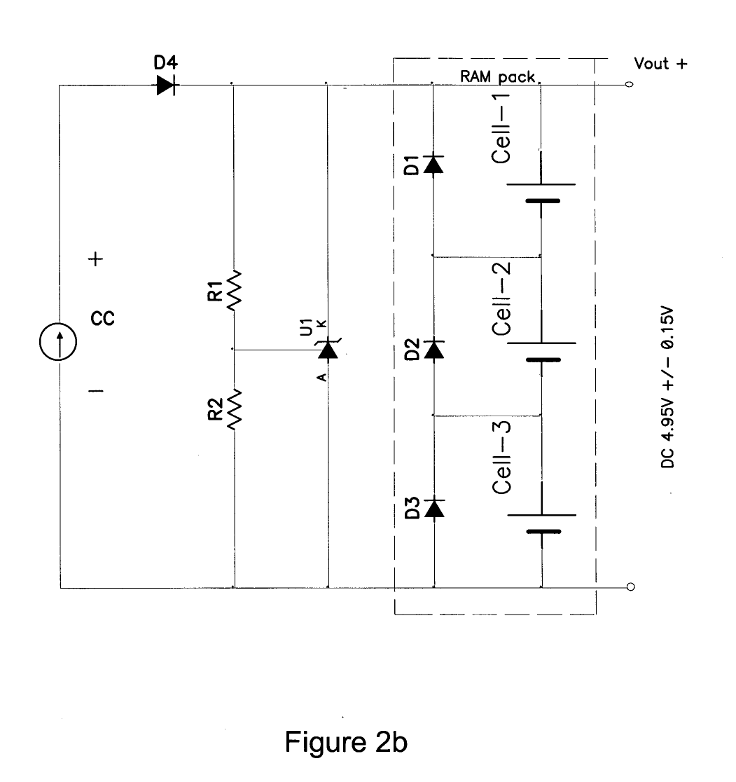

Referring to FIG. 2a, a 3-cell series RAM battery pack is shown comprising the following components:
a) 3 RAM cells, preferably AA or AAA RAM cells;
b) an overcharge protection circuit for single cell voltage protection;
c) an activation switch;
d) interconnecting tabs; and,
e) a terminal connector.

Specifications for components in FIG. 2a are described in Table 2a, below:

TABLE 2a
Component specifications in FIG. 2a.

| Component | Description | Specification |
|---|---|---|
| CC* | Constant current | 100 mA |
| | power supply | |
| U1, U2, U3 | Shunt regulator | AMS431LCM |
| | | (SOT23-3, |
| | | 1.24 V/100 mA, 2%) |
| | | or AMS431LCN |
| | | (TO-92, |
| | | 1.24 V/100 mA, 2%) |
| D1, D2, D3 | Diodes | 1N4148 |
| D3 | Rectifier | 1N4001 |
| R1, R3, R5 | Resistors | 13 K/0.1 W/5% |
| R2, R4, R6 | Resistors | 43 K/0.1 W/5% |

Referring to FIG. 2b, a 3-cell series RAM battery pack is shown comprising the following components:
a) 3 RAM cells, preferably AA or AAA RAM cells;
b) an overcharge protection circuit for pack voltage protection;
c) an activation switch;
d) interconnecting tabs; and,
e) a terminal connector.

Specifications for components in FIG. 2b are described in Table 2b, below:

TABLE 2b
Component specifications in FIG. 2b.

| Component | Description | Specification |
|---|---|---|
| CC* | Constant current | 100-150 mA |
| | power supply | |
| U1 | Shunt regulator | AMS431CN (TO92, |
| | | 2.5 V/150 mA, 1%) |
| | | or AMS431CM |
| | | (SOT-23, |
| | | 2.5 V/150 mA, 1%) |
| D1, D2, D3 | Diodes | 1N4148 |
| D4 | Rectifier | 1N4001 |
| R1 | Resistor | 680 K/0.1 W/5% |
| R2 | Resistor | 680 K/0.1 W/5% |

Referring to both FIG. 2a and FIG. 2b, if the number of cells in series is more than 2, a diode (in this case, D1, D2 & D3) connected to each cell with reversal direction can be considered to protect against very deep cell reversals. These diodes have no function during the charging process, but prevent RAM cells from being discharged too deeply under over-discharge situations, which can lead to cell reversal. If the deep voltage reversal is being avoided by other means (for example a switch means, diode, etc.) incorporated into the device that limits discharge at a predetermined voltage (for example, a cut-off voltage of 0.8V/cell), the reversal diodes D1-D3 may be omitted. Use of a discharge limiting means of this type is common in many electronics applications, such as in digital cameras and in some cordless phones.

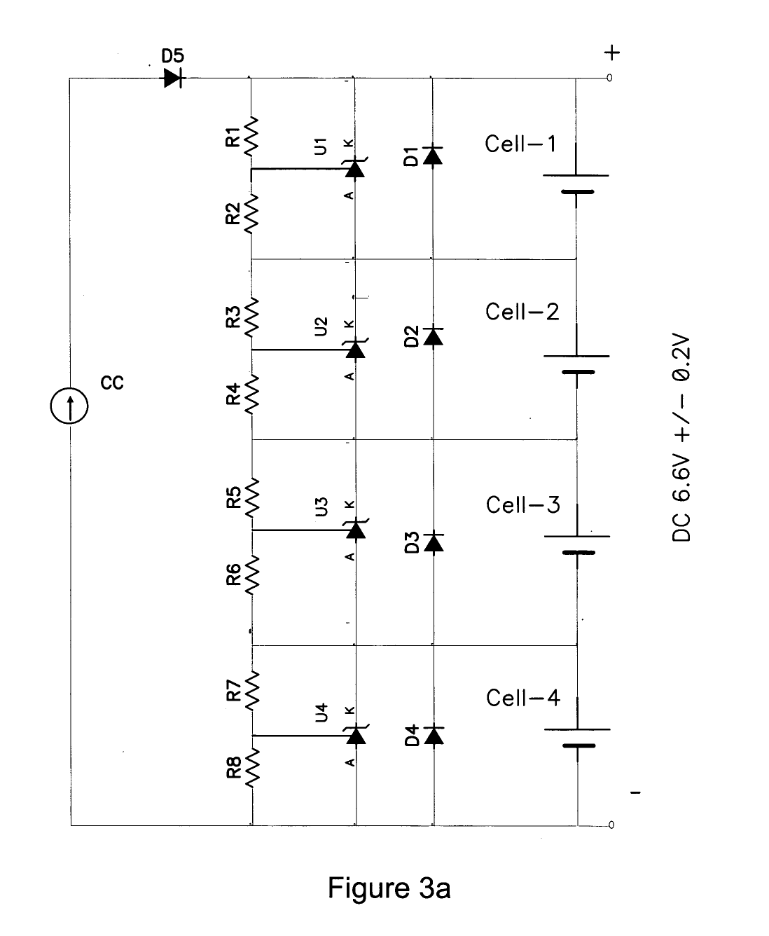

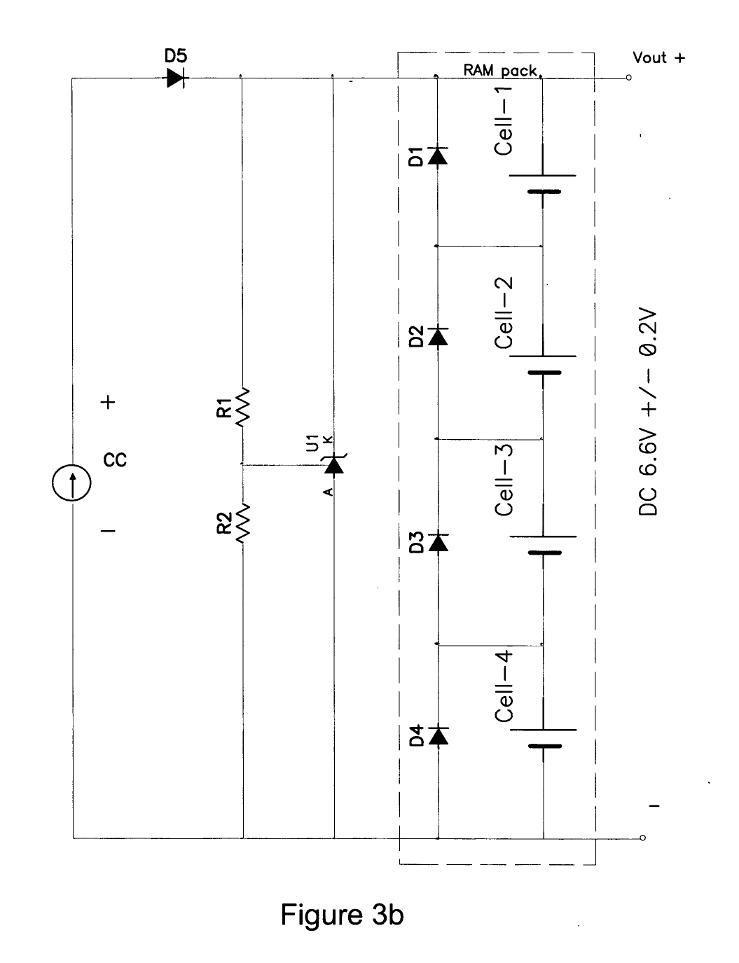

Referring to FIG. 3a, a 4-cell series RAM battery pack is shown comprising the following components:
a) 4 RAM cells, preferably AA or AM RAM cells;
b) an overcharge protection circuit for single cell voltage protection;
c) an activation switch;
d) interconnecting tabs; and,
e) a terminal connector.

Specifications for components in FIG. 3a are described in Table 3a, below:

TABLE 3a
Component specifications in FIG. 3ab.

| Component | Description | Specification |
|---|---|---|
| CC* | Constant current | 100 mA |
| | power supply | |
| U1, U2, U3 | Shunt regulator | AMS431LCM |
| | | (SOT23-3, |
| | | 1.24 V/100 mA, 2%) |
| | | or AMS431LCN |
| | | (TO-92, |
| | | 1.24 V/100 mA, 2%) |
| D1-D4 | Diodes | 1N4148 |
| D5 | Rectifier | 1N4001 |
| R1, R3, R5, R7 | Resistors | 13 K/0.1 W/5% |
| R2, R4, R6, R8 | Resistors | 43 K/0.1 W/5% |

Referring to FIG. 3b, a 4-cell series RAM battery pack is shown comprising the following components:
a) 4 RAM cells, preferably AA or AAA RAM cells;
b) an overcharge protection circuit for pack voltage protection;
c) an activation switch;
d) interconnecting tabs; and,
e) a terminal connector.

Specifications for components in FIG. 3b are described in Table 3b, below:

TABLE 3b
Component specifications in FIG. 3b.

| Component | Description | Specification |
|---|---|---|
| CC* | Constant current | 100-150 mA |
| | power supply | |
| U1 | Shunt regulator | AMS431CN (TO92, |
| | | 2.5 V/150 mA, 1%) |
| | | or AMS431CM |
| | | (SOT-23, |
| | | 2.5 V/150 mA, 1%) |
| D1-D4 | Diodes | 1N4148 |
| D5 | Rectifier | 1N4001 |
| R1 | Resistor | 390 K/0.1 W/5% |
| R2 | Resistor | 240 K/0.1 W/5% |

Referring to both FIG. 3a and FIG. 3b, if the number of cells in series is more than 2, a diode (in this case, D1, D2, D3 & D4) connected to each cell with reversal direction can be considered to protect against very deep cell reversals. These diodes have no function during the charging process, but prevent RAM cells from being discharged too deeply under over-discharge situations, which can lead to cell reversal. If the deep voltage reversal is being avoided by other means (for example a switch means, diode, etc.) incorporated into the device that limits discharge at a predetermined voltage (for example, a cut-off voltage of 0.8V/cell), the reversal diodes D1-D4 may be omitted. Use of a discharge limiting means of this type is common in many electronics applications, such as in digital cameras and in some cordless phones.

In any of the embodiments of an overcharge protection circuit described herein, means to prevent electronic leakage before use may be provided, for example, an activation key, jumper, or switch.

Other embodiments of the present invention will be evident to persons skilled in the art. Equivalents of components described herein may be substituted to achieve the same function without having an effect on the way in which the invention works. The preferred embodiments described herein are provided by way of example and are not meant to be construed in a limiting sense.

Having regard to the foregoing, we claim:

1. A rechargeable alkaline battery comprising one or more rechargeable alkaline cells in parallel with an overcharging protection circuit.

2. The battery according to claim 1, wherein the overcharging protection circuit comprises a shunt regulator, a voltage divider, and a rectifier.

3. The battery according to claim 2, wherein the overcharging protection circuit limits the charge voltage of each cell to 1.65 V.

4. The battery according to claim 2, wherein the voltage divider comprises a pair of resistors.

5. The battery according to claim 1, wherein the battery comprises two or more rechargeable alkaline cells in series.

6. The battery according to claim 5, wherein a diode is provided in parallel with each cell to protect against cell reversal during deep discharge.

7. The battery according to claim 5, wherein the overcharging protection circuit comprises two or more sub-circuits, a sub-circuit in parallel with each cell.

8. The battery according to claim 7, wherein the overcharging protection circuit comprises a rectifier in series with the sub-circuits.

9. The battery according to claim 8, wherein each sub-circuit comprises a voltage divider and a shunt regulator.

10. The battery according to claim 8, wherein each sub-circuit limits the charging voltage of its respective cell to 1.65 V.

11. The battery according to claim 7, wherein a diode is provided in parallel with each sub-circuit to protect against cell reversal during deep discharge.

12. The battery according to claim 1, wherein the overcharge protection circuit is connected with a charging circuit.

13. The battery according to claim 12, wherein the charging circuit comprises a constant current power supply.

14. The battery according to claim 13, wherein the constant current power supply comprises a solar panel.

15. The battery according to claim 12, wherein the battery further comprises an activation key to prevent cell discharge prior to initial use.

16. The battery according to claim 1, wherein one or more cells are removable from the overcharging protection circuit.

17. An electronic device comprising an overcharging protection circuit comprising a shunt regulator, a voltage divider, and a rectifier, the overcharging protection circuit connected in parallel with one or more rechargeable alkaline cells and with a charging circuit comprising a constant current power supply.

18. The battery according to claim 17, wherein one or more cells are removable from the overcharging protection circuit.
